(19) United States
(12) Patent Application Publication
(10) Pub. No.: US 2017/0286463 A1
(43) Pub. Date: Oct. 5, 2017

(54) MAINFRAME INDEX DATABASE TO SUPPLEMENT A SYSTEM CATALOG

(71) Applicant: CA, Inc., Islandia, NY (US)

(72) Inventor: Russell A. Witt, Plano, TX (US)

(21) Appl. No.: 15/086,905

(22) Filed: Mar. 31, 2016

(51) Int. Cl. G06F 17/30

(52) U.S. Cl. CPC G06F 17/30321; G06F 17/30477; G06F 17/30569

(57) ABSTRACT

A request for a particular file stored in memory of a mainframe computing system is received and the particular file is determined not to be registered in a catalog of the mainframe computing system. An index database separate from the catalog is searched for a record associated with the particular file and location of the particular file is determined from the index database. The particular file is then accessed from the identified location.

### BACKGROUND

The present disclosure relates in general to the field of computer data storage, and more specifically, to managing access to mainframe data.

Magnetic tape data storage technology has been actively utilized for computer data storage since the 1950s. Magnetic tape drives, as with other computer technology, has advanced over the intervening decades, with the storage capabilities of modern tape drives increasing exponentially. Some modern magnetic tape cartridges allow storage of multiple terabytes on a single cartridge. Storage and cost considerations have allowed physical tape drives to remain in use in modern systems despite the advent and widespread adoption of solid-state storage devices. For instance, tape libraries are maintained and used in many archival data stores. Modern systems can be configured to make use of both physical tape storage as well as solid-state storage. Indeed, some systems are configured to virtualize tape drive volumes by having data in solid state storage emulate physical tape volumes. Such “virtual tape” systems can present portions of a solid state storage component as tape libraries or tape drives for use with existing software that makes use of physical tape storage. Virtual tape records can appear to be stored entirely on tape cartridges when they are actually located in faster, hard disk storage. Virtual tape can be used, for instance, with a hierarchical storage management (HSM) system in which data is moved as it falls through various usage thresholds to slower but less costly forms of storage media, including physical tape. A catalog structure can be utilized to map the names of files within a mainframe system to the respective virtual tape, disk, or virtual tape on which the file is stored.

### BRIEF SUMMARY

According to one aspect of the present disclosure, a request for a particular file stored in memory of a mainframe computing system can be received and the particular file may be determined not to be registered in a catalog of the mainframe computing system. An index database separate from the catalog can be searched for a record associated with the particular file and location of the particular file can be determined from the index database record. The particular file can then accessed from the identified location.

### BRIEF DESCRIPTION OF THE DRAWINGS

FIG. 1 is a simplified schematic diagram of an example mainframe computing system in accordance with at least one embodiment;

FIG. 2 is a simplified block diagram of an example computing system including an example mainframe system in accordance with at least one embodiment;

FIG. 3 is a simplified block diagram of an example mainframe catalog and index database in accordance with at least some embodiments;

FIGS. 4A-4D are simplified block diagrams illustrating examples of various indexing schemes;

FIG. 5 is a simplified flowchart illustrating example techniques in connection with determining locations of files within an example mainframe system in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate suitable combination medium, including but not limited to wireless, wireline, optical fiber cable, RF, etc., or any of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

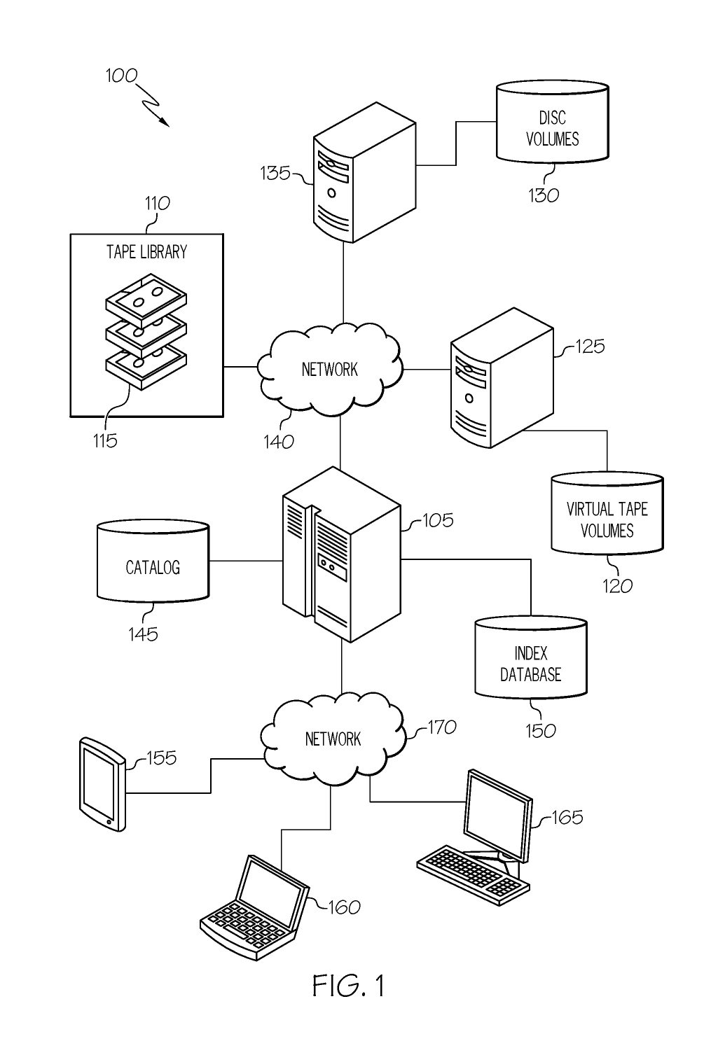

Referring now to FIG. 1, FIG. 1 is a simplified block diagram illustrating an example computing environment 100 including a mainframe computing system 105 providing software to access and utilize data stored in multiple different storage elements including, for instance, tape drive storage (such as in a tape library 110 including one or more physical tape volumes 115), virtual tape volumes 120 of a virtual tape server 125, and memory disk volumes 130 managed by a server 135. Physical tape volumes 115 can include modern or legacy tape storage media, including tape cartridges, tape reels, tape cassettes, and so on. Further, mainframe system 105 can further utilize data from non-tape storage devices (e.g., 125, 135) including sold-state, hard disk, and other non-tape drives. Non-tape storage devices (e.g., 125), in some implementations, can include one or more virtual tape volumes 120. Indeed, a non-tape storage devices (e.g., 125, 135) can, in some cases, store a mix of virtual tape files and disk storage files, among other examples. In some implementations, at least a portion of the mainframe data storage (e.g., 110, 125, 135) can be hosted remotely from and accessed over one or more networks (e.g., 140) by the mainframe computing system. Accessing a file can involve the mainframe system 105 consulting a catalog index 145 to map a requested file to a specific one of the multiple different storage elements (e.g., 110, 125, 135) utilized by the mainframe system 105. In one implementation, a separate index database can be maintained to serve as a directory of at least a subset of the universe of files intended for use by the mainframe system 105. At least some of the records in the index database 150 can indicate the storage locations of a subset or category of the universe of files, which are not listed (or often incorrectly listed) in the catalog 145. The index database 150 can thus be used to offload large portions of the records that would be traditionally included in the catalog 145, thereby reducing the size (and increasing the usability) of the catalog, among other example benefits.

In some implementations, one or more user devices (e.g., 155, 160, 165) can be included in computing environment 100 allowing one or more users to interact with and direct operation of one or more of mainframe system 105, tape library 110, storage devices 125, 135, as well as programs and applications offered with or accessing data and services provided by mainframe system 105, etc. For example, a user device (e.g., 155, 160, 165) can be used to allow a human user to interface with an application making use of data stored in storage elements (e.g., 110, 125, 135), such as archival data (e.g., stored on one or both of physical tape volumes 115 and virtual tape volumes 120), among other examples. User devices (e.g., 155, 160, 165) can access computing system 105 as well as other remotely-provided systems, applications, and resources using one or more networks (e.g., 170). Such networks (e.g., 140, 170) can include local and worldwide networks, networks employing wired and/or wireless channels, as well as private and public (e.g., the Internet) networks, among other examples.

In general, “servers,” “user devices,” “mainframes”, “computing devices,” “network elements,” “hosts,” “clients,” “computers,” and “systems,” etc. (e.g., 105, 110, 120, 155, 160, 165, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 120, 155, 160, 165, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a tape management system, virtual tape manager, or other system or subsystem of an example computing environment (e.g., 100) can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

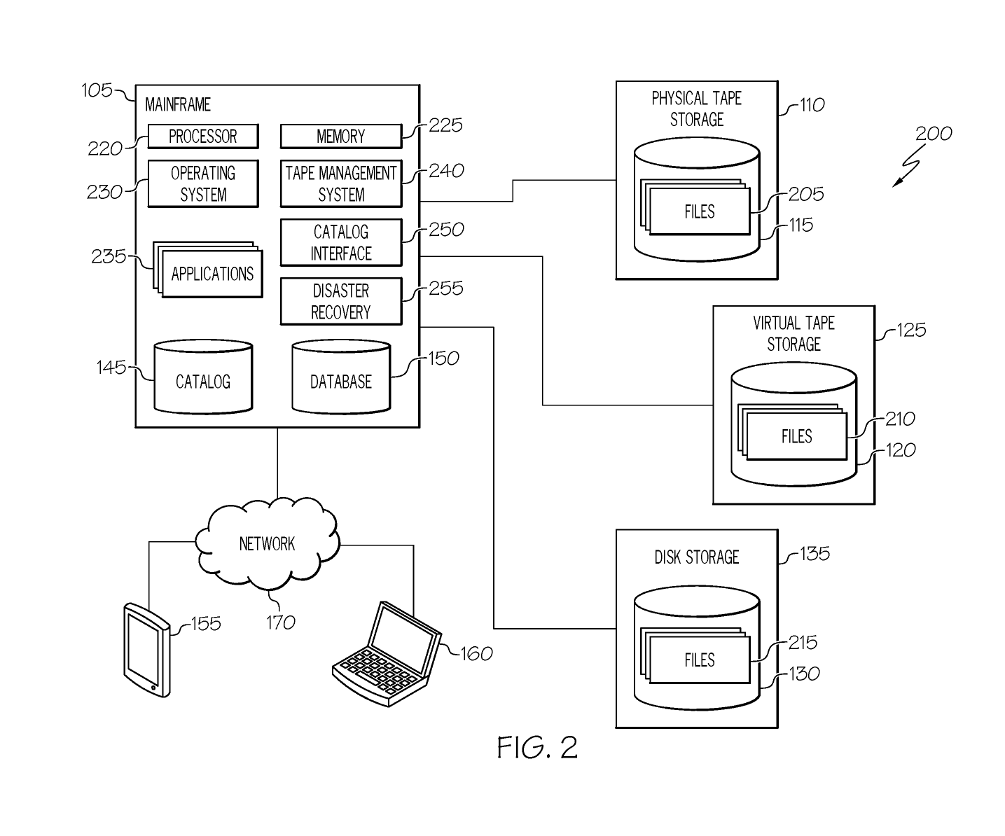

Turning to the example of FIG. 2, a simplified block diagram 200 is shown illustrating an example environment including a mainframe computing system 105 implementing a catalog interface 250 capable of utilizing a directory that divides records between a conventional mainframe catalog structure 145 and an index database 150. In one example implementation, the index database 150 can be managed through a tape management system 240 of the mainframe computing system 105, among other example implementations. The combination of the catalog structure 145 and index database 150 can host records for a collection of files 205, 210, 215 accessible by the mainframe system 105. The files may be hosted on multiple distinct storage elements (e.g., 110, 125, 135), indeed, multiple different types of storage elements (e.g., 110, 125, 135) may be utilized to host the collection of files 205, 210, 215.

Each of the catalog 145 and index database 150 can index files (e.g., 205, 210, 215) of the system by file name. Each file can have a respective record in one or both of the catalog 145 and index database 150. In some implementations, at least some of the files will be indexed in only one of the catalog 145 or the index database 150. The mainframe system 105, in some implementations, may further include one or more data processing apparatus 220 and memory elements 225, as well as other modules and components implemented in hardware and/or software of the mainframe system 105. In one example, the mainframe system 105 can include an operating system 230 within which one or more applications 235 can be executed. The applications 235 can include logic to provide a variety of functions and services and can access and utilize data in files (e.g., 205, 210, 215) in connection with their operations and features. A catalog interface 250 can be included in some implementations, and can be implemented at least in part in software. The catalog interface 250 can identify file access requests made by various applications 235 and determine whether to consult the catalog 145 or the database 150 to find the recording identifying the storage location (e.g., 110, 125, 135) (and address) of the requested file. In one example, for every file request, the catalog interface 250 can search the catalog 145 for the file's corresponding index record. If a record for the file is not found in the catalog 145, the catalog interface 250 can then search the index database 150. Upon finding the record, the catalog interface 250 can access the data of the requested file or, alternatively, pass information from the record to the requesting application (e.g., 235) to allow the application to access the requested file using the information from the corresponding record. Additionally, as files are added, deleted, or modified to cause a change to the storage location of the file, corresponding records in the catalog 145 and/or index database 150 can be modified to reflect the change. In some implementations, the catalog interface 250 can be utilized to identify a change that affects one or more records of the catalog and/or index database 150 and can manage the updating of the record.

In some implementations, mainframe system 105 can include a tape management system 240 to manage tape-based data stores (e.g., 110, 125) of the system 105. A tape management system 240 can manage both physical tape volumes (e.g., 115) as well as virtual tape volumes (e.g., 120). A tape management system 240, in some implementations, can be integrated with the mainframe system 105. In other implementations, the tape management system 240 can be provided as a standalone system (i.e., separate from other components of the mainframe system 105). A tape management system 240 can be utilized, in some instances, to manage the physical magnetic tape (as well as virtual tape), which may be utilized in the mainframe system 105 as backup information. This backup data can also include backups of the data structures implementing catalog 145 (and index database 150). Accordingly, a tape management system 240 can provide tape inventory control to protect against overwrites, designate and track “scratch” tapes, among other tape management tasks. In one implementation, index database 150 can be implemented as a database of the tape management system 240. For instance, files designated as backup files may be designated for indexing using index database 150 rather than the catalog 145. In some cases, the index database 150 can be utilized to index tape (physical and virtual) files, while non-tape files are indexed using the catalog 145, among other potential implementations.

As noted above, tape volumes can be utilized to provide a backup of application and system data (e.g., of files 205, 210, 215) of the mainframe system. Data backup can include not only the backing up of data, but also restoration of the data after a loss (e.g., whether deliberate or accidental (system failure, disk failure, disasters, etc.). In some cases, backups can be scheduled to occur at defined intervals or events, with all of the data for rebuilding and restarting the system (e.g., 105) being stored on the backup copy and at a common point in time. Data can be backed up (e.g., by a backup manager system) while the mainframe system 105 is functioning, such that the backup is made concurrent with the functioning of the mainframe system. This can drastically reduce the downtime that might otherwise occur, thereby increasing the system 105 availability. Specifically, time-consuming transfers of data to external storage media (e.g., 110, 125) can be carried out using disk-based copies of the data, while the application continues to actively use the original data. Restoring the data can also be achieved through the use of disk-based copies (e.g., virtual tapes 120), although given the enormous amount of backup data in some systems, physical tape media may be relied on heavily for the storage of such backup copies. Backup data can include full duplication (e.g., shadow copy), partial duplication (e.g., without background copy), space-efficient duplication, among other forms.

In some instances, backup data can be generated to account for changes to the system or application data and enable previous versions of the data and system to be restored from the backup. Backup data can also be created and utilized to restore from an unexpected loss, or disaster. A disaster can be any loss of the mainframe system, its applications, or data for a time. Backup copies for disaster recovery may be remote from the mainframe system and/or portable to allow the disaster recovery backups to be applied to a full or partial system disaster event. Such “remote copies” can mirror data outside and beyond the local computing systems implementing mainframe system 105. Remote copy backups may implement synchronous mirroring (e.g., Metro Mirror (MM) or Peer-to-Peer Remote Copy (PPRC)) or asynchronous mirroring (e.g., Global Mirror, Extended Remote Copy (XRC), etc.), among other examples. In some implementations, such as the example illustrated in FIG. 2, a mainframe system 105 may include a disaster recovery module (e.g., 255), which can assist in managing the restoration of application and/or system data from the backup data generated for disaster recovery. In some instances, disaster recovery module (or other backup data manager) can additionally be used to generate backup data. In some instances, in the event of a detected disaster affecting the catalog 145, disaster recovery module 255 can recover a backup of the catalog from backup files to assist in restoring the system following the disaster event, among other example features.

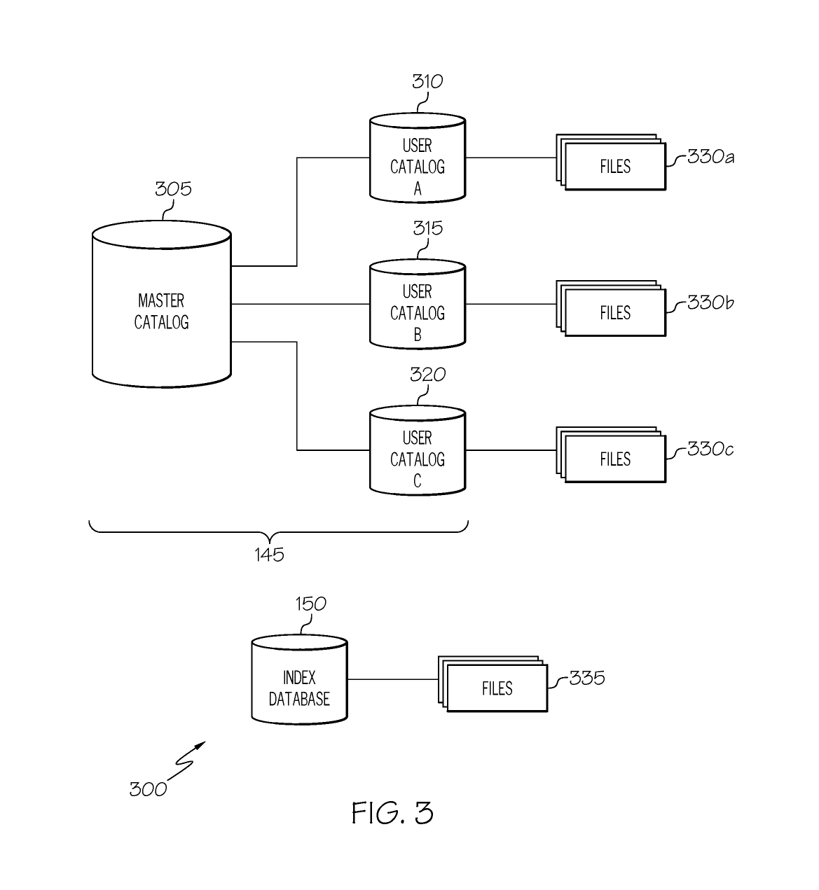

Turning to the simplified block diagram 300 illustrated in FIG. 3, example implementations of a catalog structure 145 and separate, independent index database 150 are shown. In some instances, the catalog structure 145 can be hierarchical and composed of multiple smaller user catalogs (e.g., 310, 315, 320). A subset of the files (e.g., 330a-c) can be registered with and have corresponding index records in one of the user catalogs (e.g., 310, 315, 320). The master catalog can index the component user catalogs (e.g., 310, 315, 320) and be used to identify which user catalog to search to find an index record for any given file request. As an example, files can be registered with their respective user catalog based on factors such as the name of the file (e.g., file names starting with an “A” through “B” are assigned to one user catalog, file names starting with “C” through “E” to another user catalog, etc.), the author of the file, the location where the file was created, among other examples. Accordingly, a catalog interface can identify characteristics of a file requested by an application and identify from the characteristics and the mapping of characteristics-to-user-catalog included in the master catalog 305, which of the user catalogs (e.g., 310, 315, 320) to search to find a record indicating the storage location of the requested file. In some cases, searching an entire catalog for a certain file's respective index record can be prohibitively expensive from a performance standpoint, as some catalogs may index prohibitively massive numbers of records of registered files. Accordingly, the use of user catalogs can improve the lookup performance within the catalog by allowing the catalog interface to narrow the scope of its search to a subset of index records in a respective user catalog (e.g., 310, 315, 320).

As introduced above, in addition to a mainframe catalog, a supplementary index database structure (e.g., 150) can be provided, which stores the index records for a subset (e.g., 335) of the files of a mainframe system. In some implementations, the subset of files 335 registered with the index database may not overlap with the subsets of files 330a-c registered with the catalog. In other words, in some instances, only certain types or categories of files may be reserved for registration with the index database. For instance, in one example, backup copies of files or legacy files (e.g., including disaster recovery backups) may be registered in the index database 150, while “live” and non-backup copies of files are registered in the catalog. This can reduce the overall size of the catalog 145 and further enhance performance when performing lookups within the catalog 145. For instance, the subset of files 335 selected for registration in the index database may be files for which requests are received on a substantially less frequent basis than for files registered in the catalog 145. Such files can include backup files, which may be seldom accessed relative to live files used by the mainframe system and its application. Other, non-backup files may also be registered instead with the index database. For instance, the mainframe system can automatically assess the frequency of a file's access and/or the last time the file was accessed, and determine whether to move that file to tape or simply de-register the file from the catalog and create a replacement index record in the index database.

In some cases, some files registered in the catalog can also be registered in the index database resulting in duplicate instances of index records for these files being present in each of the catalog 145 and the index database 150. In some implementations, searching the catalog for a record can be more efficient than searching for the same record were it present in the database 150. In some instances, however, the records of the index database 150 may be updated more frequently (or earlier, in the event of the creation of a new file) than records in the catalog 145. In some instances, the catalog 145 may be updated when an application creating a new file has completed creation of the new file. The index database 150, however, may update when the same application begins to create a new tape file (or even before the first record is written to the new tape file. As a result, index database 150 records may be created or updated before a corresponding duplicate record in the catalog 145 may be created.

An index record for a file can be indexed by the name of the file, allowing simple mapping of a request for the file to its respective storage location. Accordingly, an index record can also identify the address of the file's storage location (e.g., volume serial number (volser)). The index for a file can include additional information, including the date/time the index record was last updated, the type of storage location (e.g., DASD cache, physical tape, virtual tape, etc.), geographic location of the storage location, characteristics of the file itself (e.g., date/time of last access, author, owner, etc.), size of the file, whether the file has been successfully closed, among other information. Index records of the catalog 145 and index database 150, in some implementations, may have at least a partially shared format with common fields and information being included in records of each structure. Accordingly, migrating index records from the catalog 145 to the index database 150 (or from the index database to the catalog 145) can be a simplified and seamless process.

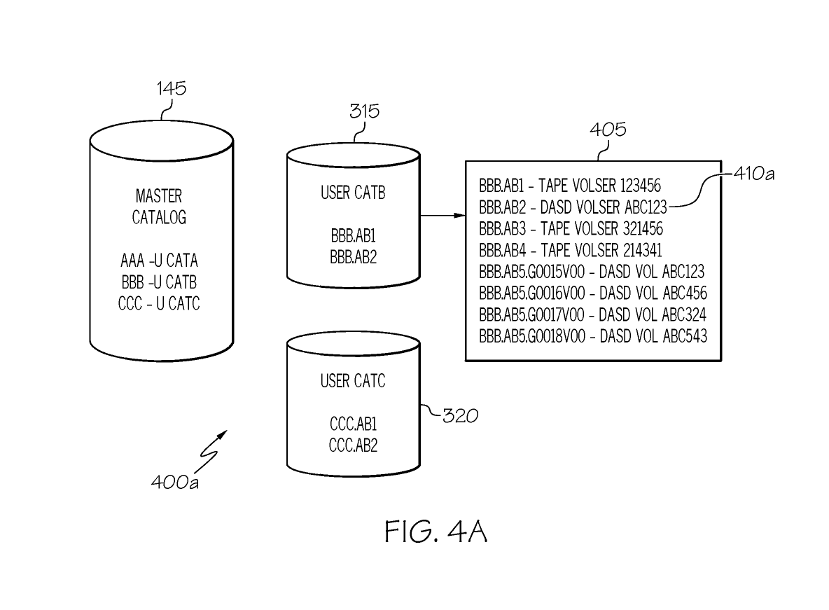

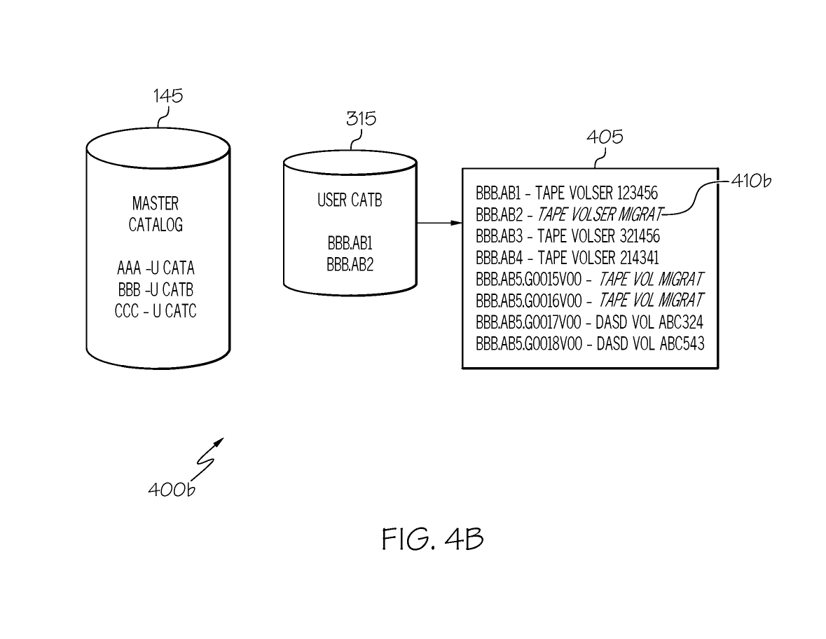

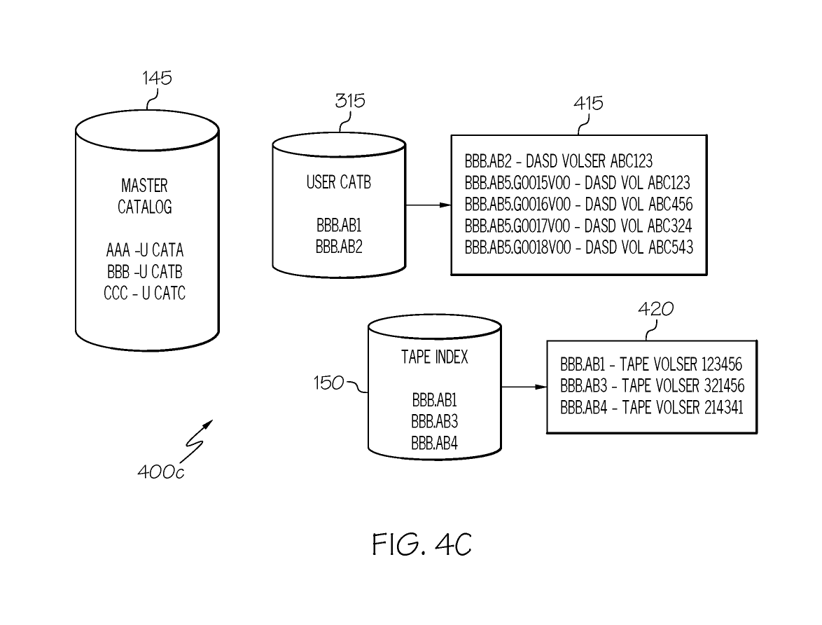

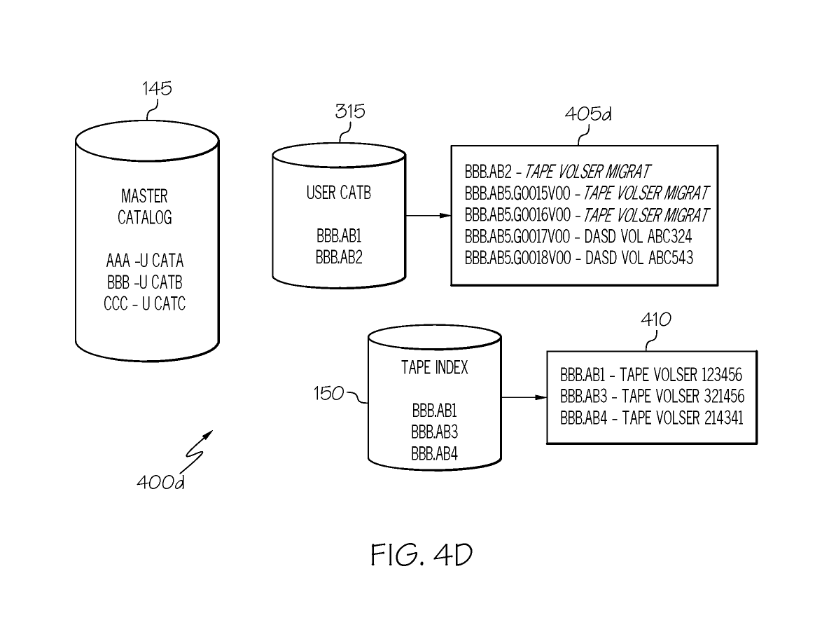

Turning to the simplified block diagrams of FIGS. 4A-4D, examples of various indexing schemes are illustrated and compared. For instance, in the examples of FIG. 4A-4B, an example data migration technique is illustrated. FIG. 4A illustrates an example master catalog 305 and user catalogs 315, 320 at a first moment in time. In this example, the files registered in User Catalog B 315 include those files with file names beginning “BBB.AB1”, “BBB.AB2,” etc. and the files registered in User Catalog C 320 include those files with file names beginning “CCC.AB1”, “CCC.AB2,” among potentially other examples. FIG. 4A includes a representation 405a of a portion of the index records included in User Catalog B 315. In this example, each record is indexed by the name of a file (e.g., “BBB.AB1,” “BBB.AB2,” “BBB.AB3,” etc.) and identifies, for the corresponding file, the type of volume (or media) on which the file is stored (e.g., TAPE, DASD, etc.) and further includes the volser of the file within the data store. For instance, file “BBB.AB1” is stored in a tape volume with volser 123456.

In some instances, a file may be migrated to another storage element. For instance, in the example of FIGS. 4A-4B, the file “BBB.AB2” is moved from a DASD cache device (at volser ABC123) to tape. In the implementation illustrated in this example, the content of the index record (410a, as shown in FIG. 4A) is replaced with a new entry (410b, as shown in FIG. 4B) that points to a pseudo volser “MIGRAT” during the migration process that moves the file's data from DASD to TAPE. In this example, the contents of the index records for files “BBB.AB5.G0015V00” and “BBB.AB5.G0016V00” have also been replaced with the new entry pseudo volser “MIGRAT” in connection with corresponding migrations to tape. In this example, a catalog interface or other process, upon discovering a reference to the pseudo volser “MIGRAT” can launch another process to access the corresponding file from tape and temporarily move the data back to a particular disk volume (or other non-backup storage device) and the pseudo volser “MIGRAT” can also be temporarily replaced with an entry corresponding to the particular disk volume. This allows the request from Allocation to be completed as if the file had always resided on the particular disk volume, hiding the fact that the file resided in tape at the time of the original catalog lookup (which resulted in the discovery of the pseudo volser “MIGRAT” entry).

In the example of FIGS. 4A-4B, an example is illustrated for handling catalog entries corresponding to files which have been moved to tape. Of note is that the size of the catalog remains the same before and after the migration of these files from disk to tape. The corresponding entries still remain within the catalog, only the values of the entry have changed (e.g., replacing the entry with the pseudo volser “MIGRAT” entry).

In another example, shown in FIG. 4C, an indexing system is shown similar to that described in other implementations herein, such as one including both a catalog 145 (for handling a first set or category of files' entries) and a separate index database 150 (for handling a second set or category of files' entries). In this particular example, the index database 150 is dedicated to indexing the (physical or virtual) tape files of a mainframe system, while the catalog 145 includes the index record entries for all other files (e.g., non-tape disk files). In the example of FIG. 4C illustrates the distribution of the same record entries as in the example catalog implementation of FIG. 4A, but within an indexing scheme that also includes tape index database 150. Accordingly, the tape files “BBB.AB1,” “BBB.AB3,” and “BBB.AB4,” which were registered in the catalog in the example of FIG. 4A, are now registered within the index database 150 (as shown in the respective record views 415, 420 of the catalog and index database implementations illustrated in FIG. 4C). As shown in FIG. 4C, the catalog does not include entries for the tape files “BBB.AB1,” “BBB.AB3,” and “BBB.AB4.” Instead, these entries are only found, in this example, in the index database 150. Likewise, disk file entries are only found in the catalog, and not in the index database in this example.

In one instance, illustrated using the example of FIG. 4C, a catalog interface can receive a request from an application for a file “BBB.AB3.” In this first example, the catalog interface can attempt to locate the file in the catalog 145, resulting in examining the Master Catalog 145 to identify that the name of the requested file indicates that it should be stored in User Catalog B (315) (if it is a file whose entry is listed in the catalog). The catalog interface software logic can then search the index record entries of Catalog B 315 and discover that no entry exists for file “BBB.AB3”. As a result, the catalog interface software can conclude that the catalog does not contain an entry for file “BBB.AB3”. Accordingly, in this example, in response to determining that the catalog does not include an entry for file “BBB.AB3,” the catalog interface can further conclude that the entry is instead in the index database 150 and initiate a search of index record entries of the index database 150. In this example, the catalog interface can then determine that the file “BBB.AB3” is stored in tape at volser 321456 (as shown in 420). On the other hand, for requests involving files (e.g., live files) registered in the catalog, index lookups can take place as is conventional, albeit in an anticipatedly improved time given the relatively smaller catalog made possible through the offloading of some records to the index database 150. One example advantage of this approach is that no additional latency is introduced for the (more common) lookups of live files registered within the catalog (indeed such latency is likely to be reduced by the smaller catalog size), with the more intensive (and longer) lookups of tape files in the index database (triggered by an initial failed lookup of the catalog) only taking place for types of files designated for registration in the index database (e.g., backup files, legacy files, etc.), for which lookups are relatively rare in comparison.

In another alternative example, rather than forcing all file requests to result in a search of the catalog (i.e., even for files that do not possess entries within the catalog, such as file “BBB.AB3”), an example catalog interface can identify (e.g., from a mapping, a value in the request, or the file name) a category of a file requested by an application. Depending on the category determined by the catalog interface, the catalog interface can either search the index record entries of the catalog or of the index database, among other examples.

Turning to the example of FIG. 4D, in some implementations, the principles of the example of FIG. 4B can be combined with the principles illustrated in FIG. 4C, as shown here. As in FIG. 4C, the example of FIG. 4D includes the provisioning of an index database 150 used to host the index records of all tape files of an example mainframe system (as shown at 420). Entries for recently migrated disk files (e.g., registered in the catalog) can in some cases be replaced with a pseudo volser entry (e.g., “MIGRAT”) to indicate the recent migration of the file to tape (as shown at 425). In some cases, an entry for the migrated file can be added to the index database 150 in connection with the migration (i.e., in addition to the pseudo volser entry at least temporarily maintained in the catalog immediately following the migration). Such a hybrid approach may be used, for instance, to hasten the return of a recently migrated file back to disk (e.g., in the event of an accidental or premature migration decision). In one example, the pseudo volser entry (and the catalog entry itself) can be deleted after the expiration of a time period, such that only the new entry in the tape index database remains for the migrated file. If, however, a request is received for a migrated file before the pseudo volser entry is deleted or expires, retrieval of the migrated file can proceed as described in the example of FIG. 4B, with the file being returned to a new disk volser and the pseudo volser entry being replaced with the new disk volser, among other examples.

As noted in the example of FIG. 4D, among other example advantages, an index database may prove useful in preserving the indexing for accidentally deleted or modified catalog entries. In one example, each time a file is deleted or modified, a copy of the file (e.g., prior to the modification or deletion) may be created and saved to tape. Accordingly, a corresponding index record can be created for inclusion in the index database (e.g., 150). In some cases, this copy may be a temporary copy, scheduled for deletion after an expiration of time or another event. Should this prior version be desired, or a deleted file requested, a search of the catalog may reveal that the corresponding entry has also been deleted, causing a search of the index database to be performed to find (and in some cases recover) the file from the copy.

In still other examples, a copy of the catalog (or portion thereof) may itself be backed-up (e.g., to tape). A backup copy of the catalog may likewise be registered to index database. In some cases, the backup copy of a catalog may be registered (and include index records) in both the catalog itself and the index database. In one example, an index database storing index records of the backup files of a system (including the catalog backup) maybe managed by a tape management system. In such an example, changes to the catalog backup (and other backup files) maybe identified (and reflected in the corresponding index database entries) more frequently and earlier than by the logic managing the catalog. Accordingly, in the event of a disaster or other outage which causes the permanent or temporary loss of the catalog prior to the changes being reflected in the corresponding record for the catalog backup within the catalog. Indeed, one or more records of the catalog may be out-of-date during a disaster recovery operation. To correctly restore the catalog from its backup in such an example, a search of both the catalog and the index database can be made, with the index database information given precedence over the catalog entry for the catalog backup. Accordingly, the catalog can be recovered from a file that is itself either incorrectly or not at all registered in the catalog (or disaster recovery catalog), among other example use cases. For instance, other files may also have duplicate index entries in the catalog and index database, with the index database entries given priority over the corresponding catalog entries in the event of a disaster recovery event, which potentially compromises the temporal accuracy of the catalog entry.

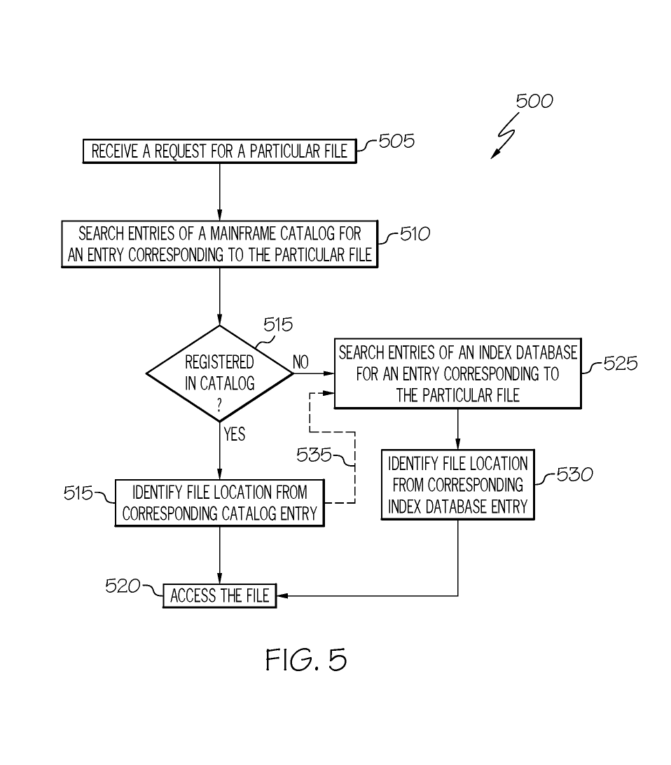

FIG. 5 is a simplified flowchart 500 illustrating an example technique for locating a file within a mainframe computing system. For instance, a request for a particular file can be identified, for instance, by receiving 505 the request (e.g., at a catalog interface or other mainframe module) from a software application. The request can identify the name of the requested file. Entries of a mainframe catalog structure can be searched 510 for an entry corresponding to the requested file. For instance, the catalog structure can be indexed by file name and a master catalog and user catalog of the catalog structure can be searched to determine (at 515) whether an entry exists for the requested file in the catalog. If no entry exists in the mainframe catalog, it can be determined 515 that the requested file is not registered in the catalog. If, however, an entry is found through the search, the corresponding catalog entry can be read by the catalog interface to identify a storage location (e.g., volser) of the file (as identified in the catalog entry record). In some cases, the storage location can be communicated to the application to allow access 520 to the file, or the file may be accessed 520 on behalf of and delivered to the application by a resource management module of the mainframe system.

In one implementation, if it is determined (at 515) that the requested file is not registered in the catalog, record entries of an index database structure separate and distinct from the catalog can be searched 525 to identify a record for the requested file. The record entries in the index database can also be indexed by file name and identify the storage location (e.g., volser) of the requested file. The file location can thereby be identified 530 using the index database record to allow access 520 to the file by the requesting mainframe resource (e.g., application).

In some examples, both the catalog and index database may be used to determine the actual location of a requested file. For example, entries may be maintained in both the catalog and the index database for some files. Further, entries in the index database can be considered more reliable or up-to-date or secure, and results obtained from a read of the catalog entries (e.g., 515) can be double-checked (e.g., at 535) by searching the index database to determine if the file location indicated in the index database entry record differs from the entry record for the same file in the catalog. From these searches, the actual location of the requested file can be determined or confirmed to allow access 520 to the requested file, among other example use cases, implementations, and features.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
identifying a request for a file stored in memory of a mainframe computing system;
determining that the file is not registered in a catalog of the mainframe computing system;
searching an index database separate from the catalog;
determining location of the file from the index database; and
accessing the file from the location.

2. The method of claim 1, wherein the index database is searched in response to determining that the file is not registered in the catalog.

3. The method of claim 2, wherein determining that the file is not registered in the catalog comprises searching at least a portion of the catalog to determine that no entries exist for the file in the catalog.

4. The method of claim 1, wherein the file comprises a particular file, the catalog comprises a first plurality of index records for a first plurality of files, the index database comprises a second plurality of index records for a second plurality files, and the second plurality of files comprises the particular file.

5. The method of claim 4, wherein determining that the particular file is not registered in the catalog comprises determining that the first plurality of index records do not comprise an index record for the particular file.

6. The method of claim 4, wherein the second plurality of files comprise backup files.

7. The method of claim 6, wherein the backup files comprise a backup of the catalog.

8. The method of claim 4, wherein the second plurality of files comprises archive files.

9. The method of claim 4, wherein the second plurality of files comprises tape files.

10. The method of claim 9, wherein the tape files comprise files stored in physical or virtual tape.

11. The method of claim 9, wherein the first plurality of files comprises non-tape files.

12. The method of claim 9, wherein the index database comprises a database of a tape management system.

13. The method of claim 1, wherein the request comprises a first request for a first file and the method further comprises:
identifying a second request for a second file of the mainframe computing system;
searching the catalog to identify a catalog entry corresponding to the second file;
determining a location of the second file from the catalog entry; and
access the file from the determined location of the second file without using the index database.

14. The method of claim 1, wherein the request comprises a first request for a first file and the method further comprises:
identifying a second request for a second file of the mainframe computing system;
searching the catalog to identify a catalog entry corresponding to the second file;
determining a first location of the second file from the catalog entry corresponding to the second file;
searching the index database for an entry in the index database corresponding to the second file;
determining whether a different second location is identified for the second file in the index database;
determining the actual location of the second file from the searching of the catalog and index database; and
accessing the second file from the determined actual location of the second file.

15. The method of claim 14, wherein:
if the index database comprises an index database entry corresponding to the second file, a location identified in the index database entry is used as the actual location, and if no index database entry is found in the index database, a location identified in the catalog entry corresponding to the second file is used as the actual location.

16. The method of claim 1, further comprising:
identifying migration of a second file of the mainframe system from a disk volume to a tape volume; and
modifying an entry in the catalog corresponding to the second file to identify a pseudo volume identified value to indicate the migration, wherein migration of the second file comprises creation of an entry in the index database for the second file, and the entry in the index database for the second file identifies a serial number of the tape volume.

17. A computer program product comprising a computer readable storage medium comprising computer readable program code embodied therewith, the computer readable program code comprising:
computer readable program code configured to determine that a catalog of the mainframe computing system does not include entries for a requested file;
computer readable program code configured to search an index database separate from the catalog to identify an entry for the file; and
computer readable program code configured to determine a storage location of the file from the entry of the index database.

18. A system comprising:
a data processing apparatus;
a memory device;
a mainframe catalog structure comprising a first plurality of records;
an index database structure comprising a second plurality of records;
a catalog interface of a mainframe, the catalog interface comprising logic executable by the data processing apparatus to:
determine that the first plurality of records does not comprise a record identifying a storage location of a particular requested file;
search the index database structure to identify a particular record corresponding to the particular file in the second plurality of records; and
determine location of the file from the particular record of the index database structure.

19. The system of claim 18, further comprising a tape management system to manage records of the index database structure.

20. The system of claim 19, wherein the second plurality of records comprise records for file managed by the tape management system.
